(19) United States
(12) Patent Application Publication
(10) Pub. No.: US 2009/0122568 A1
(43) Pub. Date: May 14, 2009

(54) LED Headlamp with an LED Turn Signal

(76) Inventors: James R. McFadden, Oxford, MI (US); Ronald O. Woodward, Yorktown, VA (US)

Correspondence Address: MAGNA INTERNATIONAL, INC., 337 MAGNA DRIVE, AURORA, ON, L4G-7K1, CA

(21) Appl. No.: 12/117,921

(22) Filed: May 9, 2008

Related U.S. Application Data
(60) Provisional application No. 60/928,402, filed on May 9, 2007.

(51) Int. Cl. F21V 9/08

(52) U.S. Cl. 362/510

(57) ABSTRACT

A turn signal indicator lamp is operated with LED light sources. The LED light sources produce white light which is filtered, before and/or after transfer of the light from the LED source to the lens, to obtain the desired amber light without unduly reducing the amount of light available to create the desired turn signal indicator light pattern.

### CROSS-REFERENCE TO RELATED APPLICATION

This application claims the benefit of U.S. Provisional Application No. 60/928,402, filed May 9, 2007.

### FIELD OF THE INVENTION

The present invention relates to an LED headlamp. More specifically, the present invention relates to an LED headlamp with an LED turn signal.

### BACKGROUND OF THE INVENTION

LED headlamps are being developed for automobiles and other vehicles by a variety of manufacturers. The assignee of the present invention has developed several innovative LED headlamps, headlamp components and lighting modules and has pending or published patent applications for these innovations.

While LED headlamp systems have numerous advantages, to date it has not been cost effective to provide such headlamps with amber turn signals which employ LED light sources. Specifically, while many recent advances have been made in the efficiency and light output levels of LEDs which produce white light (white LEDs), similar advances for LEDs which produce amber light (amber LEDs) have been elusive.

To date, amber LEDs have significantly lower output levels of light than comparable white LEDs and/or the color of the light output from amber LEDs changes as the operating temperature of the amber LED changes.

The lower levels of light produced by amber LEDs thus requires more amber LEDs to be used in any turn signal to meet the various regulatory light levels for turn signals. This would result in an increased manufacturing cost for such a turn signal and/or can creating packaging issues relating to the need to fit a sufficient number of amber LEDs into the available space while still providing adequate cooling for the amber LEDs.

More significantly, the color of the amber light emitted by turn signals is also set by various regulations and the color changes resulting from changes in the operating temperature of amber LEDs poses a significant impediment to their use in turn signals.

### SUMMARY OF THE INVENTION

It is an object of the present invention to provide a novel LED turn signal lamp and/or an LED headlamp with an LED turn signal which obviates or mitigates at least one disadvantage of the prior art.

According to a first aspect of the present invention, there is provided a turn signal indicator light, comprising: at least one semiconductor light source producing white light; a lens for focusing light into a desired turn signal indicator light pattern and emitting the focused light from a lens output surface; a light transfer device including a light capture surface located adjacent the at least one semiconductor light source, to capture substantially all of the light emitted by the semiconductor light source, and transferring the captured light to the lens; and wherein at least one of the light capture surface and the lens output surface has a filter material diffused therein to filter the white light to produce an amber light for the desired turn signal indicator light pattern.

The present invention provides a turn signal indicator lamp which is operated with LED light sources. The LED light sources produce white light which is filtered, before and/or after transfer of the light from the LED source to the lens, to obtain the desired amber light without unduly reducing the amount of light available to create the desired turn signal indicator light pattern.

According to yet another aspect of the present invention, there is provided a turn signal indicator light, comprising: at least one semiconductor light source producing white light; a lens for focusing light into a desired turn signal indicator light pattern and emitting the focused light from a lens output surface; a light transfer device including a light capture surface located adjacent the at least one semiconductor light source, to capture substantially all of the light emitted by the semiconductor light source, and transferring the captured light to the lens; and at least one filter member located in the optical pathway between the light capture surface and the lens output surface to filter the white light to produce an amber light for the desired turn signal indicator light pattern.

### BRIEF DESCRIPTION OF THE DRAWINGS

Preferred embodiments of the present invention will now be described, by way of example only, with reference to the attached Figures, wherein:

FIG. 1 shows a perspective view of the front, top and side of the light sources of a headlamp fixture in accordance with the present invention;

FIG. 2 shows another perspective view of the front, top and side of the light sources of the headlamp fixture of FIG. 1 wherein the lens of the projector has been removed;

FIG. 3 shows a schematic representation of the side of a D-Element which can be used in the headlamp of FIG. 1; and

FIG. 4 shows a schematic representation of the side of another D-Element which can be used in the headlamp of FIG. 1.

### DETAILED DESCRIPTION OF THE INVENTION

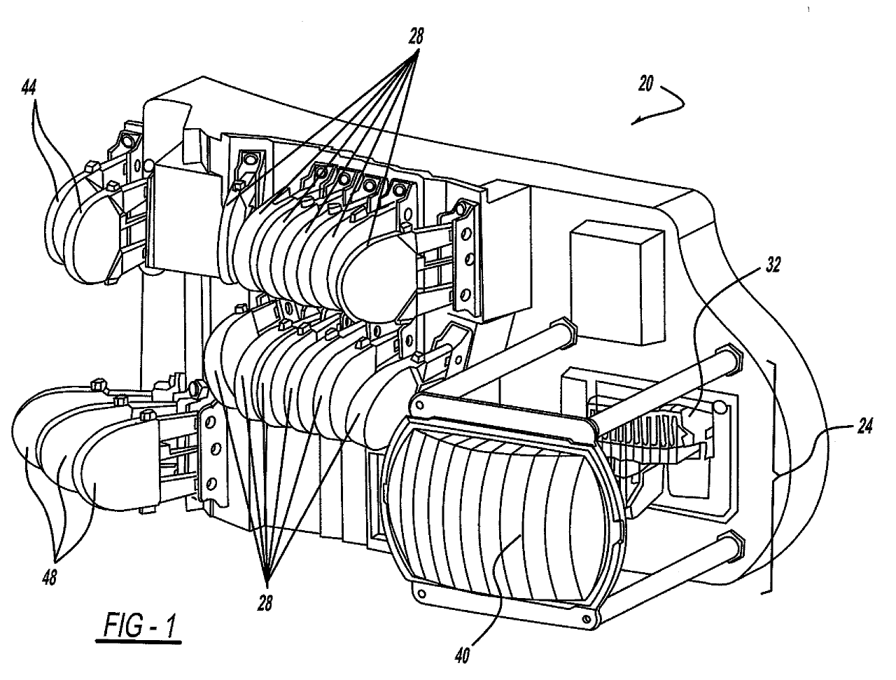

A headlamp fixture in accordance with the present invention is indicated generally at 20 in FIG. 1. Headlamp 20 includes a projector assembly 24, which provides focused areas of greater illumination to form “hotspots” in desired headlamp beam patterns, and a series of fill light assemblies 28, referred to herein a D-Elements, which provide the necessary fill light in desired headlamp beam patterns. The projector assembly 24 and D-Elements 28 can be similar to those of U.S. patent application Ser. No. 11/393,023 and PCT Patent Application No. PCT/US2006/045766 to the assignee of the present invention. The contents of these applications are incorporated herein by reference as part of the specification of this application.

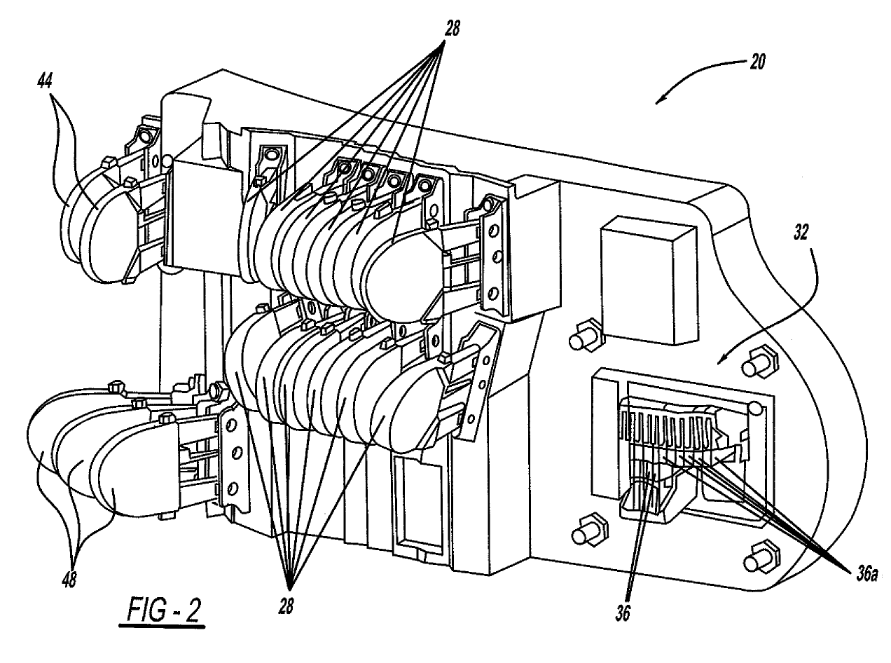

Projector assembly 24 comprises a light engine 32, best seen in FIG. 2, which includes several semiconductor light sources, such as light emitting diodes (LEDs), which emit light that is transferred, via light pipes 36, to a projector lens 40 that directs the light to contribute to the desired headlamp patterns.

More detail of a light engine 32 which is suitable for use in headlamp 20 is disclosed in U.S. patent application Ser. No. 11/787,303 to the assignee of the present invention. The contents of this application are incorporated herein by reference as part of the specification of the application.

In addition to projector assembly 24 and fill light D-Elements 28, headlamp 20 can include additional light sources, such as D-Elements 44 or any other suitable light source, as a corner lamp.

Headlamp 20 further includes at least one, and in the illustrated embodiment two, LED light sources 48 which function as a turn signal indicator lamp. LED light sources 48 include at least one white LED which produces light, a lens to focus the light into a desired turn signal beam pattern and a light transfer device, such as a light pipe, which receives light from the white LED and transfers it to the focal point of the lens.

In the illustrated and presently preferred embodiment, LED light sources 48 are D-Elements which are similar to fill light D-Elements 28. The D-shaped body of these D-Elements include an integrally formed light pipe and lens.

In order to produce the amber colored light required for turn signal indicator lamps, the light transfer device and/or lens of LED light sources 48 include a filter material though which the light from the white LED sources passes to obtain amber light. While such filtering approaches are well known, problems exist with the efficiency at which the light produced by the LED can be transferred to and pass through the lens. In particular, as LEDs have relatively limited output levels of light that they produce, compared to incandescent bulbs and other light sources, it is desired that the transfer and focusing of the LED-produced light be very efficient to ensure that adequate illumination levels be obtained.

The present inventors have determined that conventional techniques and materials for applying a filter to light transfer and lens devices, such as the above-mentioned D-Elements, is not suitable as the transfer of light through the light pipe and/or lens typically involves several reflections of the light through the light pipe and/or lens. Ideally, these reflections are achieved as total internal reflections (TIRs) with minimal loss of illumination during the reflection. However, if a filter material is applied to the exterior of the light transfer device and/or the lens, this filter material interferes with the TIR properties of light source 48 and reduces the overall transmission and output of the light.

Conversely, if the material from which the transfer device an/or lens is fabricated includes a filter material to convert the white light from the LED to the desired amber light, the passage of the light through the filter material along the entire light path of the LED light source also results in a significant and unacceptable reduction in the transmission and output of the light.

Accordingly, the present inventors have created a light transfer device and/or lens which includes a suitable filter material and which is sufficiently efficient for use in LED turn signal indicators employing white LED light sources.

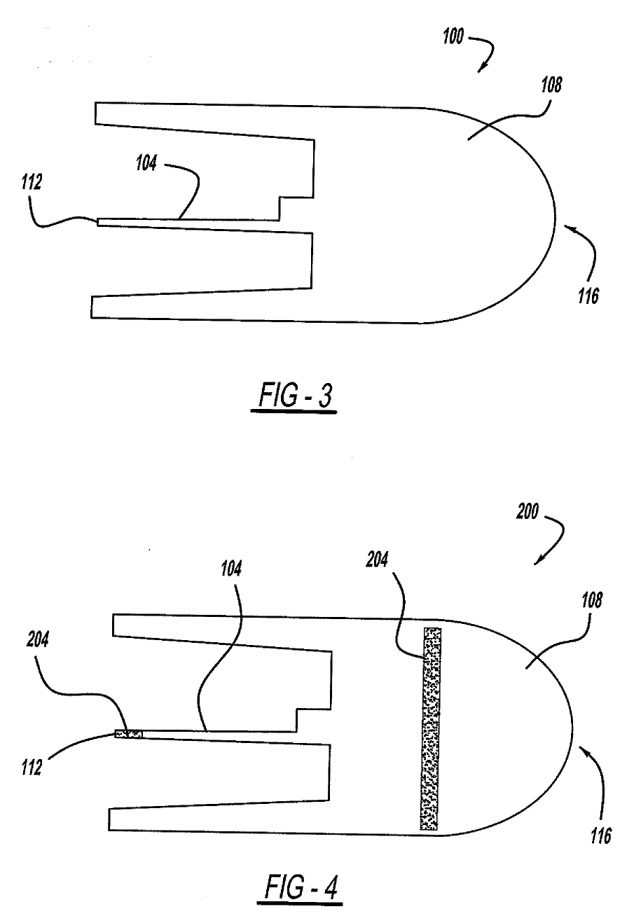

FIG. 3 shows a D-Element 100 which includes a light transfer device, light pipe 104, and a lens 108. D-Element 100 can be formed of any suitable material with appropriate optical properties, such as Acrymid™ 815, manufactured by CYRO Industries, Parsippany, N.J. And can be molded, cast or otherwise formed as desired.

Light pipe 104 includes a light receiving surface 112 which is a substantially flat surface designed to be located adjacent the light emitting surface of an LED light source to capture substantially all of the light emitted by the LED light source. The light which is captured at light receiving surface 112 is transferred along light pipe 104, typically undergoing several total internal reflections, to lens 108 where it is focused into the desired light output pattern.

In the present invention, the inventors have determined that diffusing an appropriate filter material into light receiving surface 112, and/or into the output surface 116 of lens 108, will result in the white light captured at light receiving surface 112 being filtered to the appropriate, desired, amber color without undue loss of light output from lens output surface 116. Additionally, by diffusing the filter material into light receiving surface 112 and/or lens output surface 116, rather than by coating these surfaces, undesired optical effects which can occur due to difference in coating thicknesses can be avoided.

In a present embodiment of the invention, D-Element 100 is appropriately masked and light receiving surface 112 is immersed into a diffusible filter material, such as Aura Color Infusion, manufactured by Bayer Chemical, Pittsburgh, and this filter material diffuses into light pipe 104 adjacent light receiving surface 112. The specific amount of diffusion which occurs and/or which is desirable, is dependent upon a variety of factors, including the temperature of the filter material, the immersion time and the material from which the D-Element is manufactured, those of skill in the art will be able to empirically determine an appropriate combination of process factors.

If additional filtering is required, or if it is desired to not apply the filter material to light capture surface 112, D-Element 100 can be further masked and lens output surface 116 can have the filter material diffused into it.

Once the filter material is appropriately diffused into light pipe 104 and/or lens 108, white light from an LED source captured at light capture surface 112 is relatively efficiently transferred to lens 108 via reflections which achieve TIR and the white light is filtered, either at light capture surface 112, or lens output surface 116, or both, to the desired amber color.

FIG. 4 shows another embodiment of a light source 48 in accordance with the present invention. In this embodiment, light source 48 is a modified D-Element 200 which is similar to that of FIG. 3, and like components are indicated with like reference numerals. However, in D-Element 200, instead of diffusing a suitable filter material into part of D-Element 200, at least one filter member 204 is included in the optical path. In the illustrated embodiment, a first filter member 204 is included adjacent light receiving surface 112 and a second filter member 204 is located adjacent lens 108.

Filter member 204 is manufactured from the same optical material, with a suitable filter material added, as the remainder of D-Element 200, to ensure that the refractive index of filter member 204 is the same as the bulk of D-Element 200 to allow the light received at light receiving surface 112 to propagate through D-Element 200 via total internal reflection.

D-Element 200 can be formed in an injection molding process by providing a first shot of optical material containing the filter material to form filter member 204 and then providing a second shot of clear optical material to form the rest of D-Element 200.

Alternatively, filter member 204 can be formed in a first mold from optical material with the filter material added. Filter member 204 can then be removed from the mold and polished to obtain optically flat surfaces, or otherwise processed, if desired and then loaded into a second mold wherein it is overmolded with clear optical material to obtain finished D-Element 200.

While in FIG. 4 the shape, along the optical path, of filter elements 204 is relatively straightforward, it should be apparent to those of skill in the art that more complex shapes can be employed, if desired, to have all light from an LED source that is transmitted through D-Element 200 traverse a similar length through filter member 204 to obtain a generally even color of the light exiting lens 108. For example, filter member 204 adjacent lens 108 can be arc-shaped or otherwise curved, if desired.

The present invention provides a headlamp which employs semiconductor light sources, such as light emitting diodes, and which includes white LED light sources which act as turn signal indicator lights with amber output light. The use of white LED light sources provides a relatively high level of output illumination and this produced white light is appropriately filtered to obtain the desired amber light. While in the discussion above the LED turn signals have been shown as being part of a headlamp fixture, the present invention is not so limited and the LED turn signal indicators can be employed in separate enclosures without headlamps if desired for stylistic reasons. Further, the LED turn signals of the present invention can be employed in tail light fixtures, if desired.

The present invention provides a turn signal indicator lamp which is operated with LED light sources. The LED light sources produce white light which is filtered, before and/or after transfer of the light from the LED source to the lens, to obtain the desired amber light without unduly reducing the amount of light available to create the desired turn signal indicator light pattern.

The above-described embodiments of the invention are intended to be examples of the present invention and alterations and modifications may be effected thereto, by those of skill in the art, without departing from the scope of the invention which is defined solely by the claims appended hereto.

We claim:

1. A turn signal indicator light, comprising:
at least one semiconductor light source producing white light;
a lens for focusing light into a desired turn signal indicator light pattern and emitting the focused light from a lens output surface;
a light transfer device including a light capture surface located adjacent the at least one semiconductor light source, to capture substantially all of the light emitted by the semiconductor light source, and transferring the captured light to the lens; and
wherein at least one of the light capture surface and the lens output surface has a filter material diffused therein to filter the white light to produce an amber light for the desired turn signal indicator light pattern.

2. The turn signal indicator light of claim 1 wherein the turn signal indicator light is a component in a headlamp fixture.

3. The turn signal indicator light of claim 1 wherein the turn signal indicator light is a component in a tail lamp fixture.

4. The turn signal indicator light of claim 1 wherein the lens and the light transfer device are in the form of a D-Element.

5. The turn signal indicator light of claim 4 wherein the turn signal indicator light comprises two D-Elements.

6. A turn signal indicator light, comprising:
at least one semiconductor light source producing white light;
a lens for focusing light into a desired turn signal indicator light pattern and emitting the focused light from a lens output surface;
a light transfer device including a light capture surface located adjacent the at least one semiconductor light source, to capture substantially all of the light emitted by the semiconductor light source, and transferring the captured light to the lens; and
at least one filter member located in the optical pathway between the light capture surface and the lens output surface to filter the white light to produce an amber light for the desired turn signal indicator light pattern.
